(19) United States
(12) Patent Application Publication
(10) Pub. No.: US 2025/0088015 A1
(43) Pub. Date: Mar. 13, 2025

(54) MOBILE CHARGING DEVICE

(71) Applicant: MOMAX TECHNOLOGY (SHENZHEN) CO., LTD, Shenzhen, Guangdong (CN)

(72) Inventor: Dongsheng Zheng, Shenzhen, Guangdong (CN)

(21) Appl. No.: 18/284,551

(22) PCT Filed: Nov. 10, 2022
(86) PCT No.: PCT/CN2022/131225

§ 371 Date: Sep. 28, 2023

(51) Int. Cl. H02J 7/00; H02J 50/10

(52) U.S. Cl. CPC H02J 7/0044; H02J 7/0013; H02J 50/10

(57) ABSTRACT

The invention relates to the technical field of charging devices. The mobile charging device is used for charging at least one electrical device and it comprises a housing assembly and a charging assembly; the housing assembly has an outer surface on which a plurality of first charging positions and second charging positions are arranged; the first charging position and the second charging position are respectively used for limiting the electrical device; the charging assembly comprises a plurality of first charging modules and second charging modules; each first charging module set is arranged in each first charging position one by one, and each second charging module set is arranged in each second charging position one by one; the first charging module is used for charging the electrical device in the first charging position, and the second charging module is used for charging the electrical device in the second charging position.

### TECHNICAL FIELD

The invention relates to the technical field of charging devices, in particular to a mobile charging device.

### BACKGROUND OF THE INVENTION

Mobile charging device, which is used to store electric energy, has the advantage of being convenient for users to carry. According to the different needs of consumers, its power storage capacity is becoming more and more perfect and strengthened, while its functions are becoming more and more abundant.

However, the existing mobile charging devices still have some shortcomings. For example, with the continuous development of portable terminals, various terminals need to use different charging interfaces to charge, or use different size and power charging positions to charge, while a single mobile charging device usually only has a single number and type of charging positions, and the types of products that can be charged by a single mobile charging device are narrow, that is, the charging pertinence is single, and the charging universality of a single mobile charging device is poor.

### BRIEF SUMMARY OF THE INVENTION

### Technical Issue

The invention aims to solve the technical problem of providing a mobile charging device with strong charging universality.

### SOLUTION TO THE ISSUE

### Technical Solution

The technical scheme adopted by the invention for solving the technical problems is as follows:
The application provides a mobile charging device, which is used for charging at least one electrical device and comprises a housing assembly and a charging assembly;
The housing assembly has an outer surface, and the outer surface is provided with a plurality of first charging positions and a plurality of second charging positions; The first charging position and the second charging position are respectively used for limiting the electrical device;
The charging assembly comprises a plurality of first charging modules and a plurality of second charging modules; Each of the first charging modules is one-to-one correspondingly arranged in each of the first charging positions, and each of the second charging modules is one-to-one correspondingly arranged in each of the second charging positions;
The first charging module is used for charging the electrical device in the first charging position, and the second charging module is used for charging the electrical device in the second charging position.

In some embodiments, the outer surface is also provided with a plurality of third charging positions, and the third charging positions are used for limiting the electrical device;

The charging assembly also comprises a plurality of third charging modules, each of which is arranged in each of the third charging positions one by one, and the third charging module is used for charging the electrical device in the third charging position.

In some embodiments, the outer surface is provided with a first charging position, a second charging position and a third charging position.

In some embodiments, the first charging position is provided with an earphone box storage tank for accommodating an earphone box, the second charging position is provided with a boss for supporting a mobile phone, and the third charging position is provided with a watch charging element for supporting a watch;

The first charging module comprises an earphone box wireless charging module arranged in the first charging position, the second charging module comprises a mobile phone wireless charging module arranged in the second charging position, and the third charging module comprises a watch wireless charging module arranged in the watch charging element.

In some embodiments, the third charging position is provided with a receding groove, the watch charging element is movably connected with the housing assembly, and the receding groove is used for accommodating the watch charging element.

In some embodiments, the mobile charging device further comprises a cover plate arranged on the housing assembly, and the cover plate is provided with a position avoidance hole;

Wherein, the cover plate is used for detachable cover on the outer surface, so that the cover plate shields or exposes the first charging position; the position avoidance hole is used for exposing the second charging position on the cover plate.

In some embodiments, the mobile charging device further comprises a cover magnetic attraction part and a plurality of soft rubber pads;

The cover magnetic attraction part is arranged on the housing assembly or the cover plate, the cover magnetic attraction part is used for detachable adsorbing and fixing the cover plate, the soft rubber pads are arranged on the outer surface or the cover plate, and at least part of the soft rubber pads are used for respectively contacting with the cover plate and the electrical device in the first charging position.

In some embodiments, the mobile charging device further comprises an electronic control assembly and a battery, the electronic control assembly comprises a first circuit board and a second circuit board connected to each other, and the battery is connected to the electronic control assembly;

The housing assembly comprises an upper housing and a lower housing connected with each other, wherein the upper housing and the lower housing together define an accommodation space;

The battery is arranged in the accommodation space, the end of the battery and the inner wall of the accommodation space together define an installation position, the first circuit board is arranged in the installation position, and the second circuit board is arranged between the battery and the inner wall of the accommodation space.

In some embodiments, the housing assembly further comprises an upper cushioning member disposed between the battery and the upper housing, and a lower cushioning member disposed between the battery and the lower housing.

In some embodiments, two fixing frames are provided on the first circuit board, and the fixing frames are used for inserting between the battery and the inner wall of the receiving space from opposite sides.

### BENEFICIAL EFFECTS OF THE INVENTION

### Beneficial Effects

The mobile charging device of the invention has at least the following beneficial effects:

The mobile charging device of the invention relates to the technical field of charging devices. By arranging a first charging position and a second charging position on the outer surface of a housing assembly, and arranging a first charging module in the first charging position and a second charging module in the second charging position, the electrical devices of different types or the same type can be respectively accommodated in the first charging position and the low charging position, thus enhancing the charging universality of the mobile charging device.

### BRIEF DESCRIPTION OF THE SEVERAL VIEWS OF THE DRAWINGS

### Description the Drawings

The invention will be further explained with reference to the attached drawings and embodiments, in which:

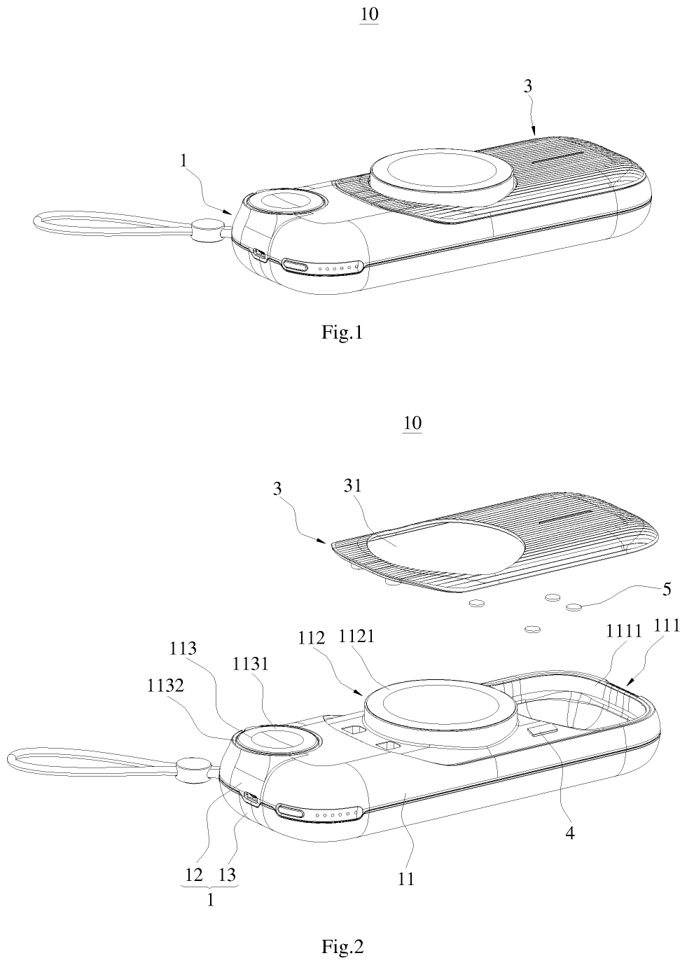

FIG. 1 is a structural schematic diagram of a mobile charging device in some preferred embodiments of the invention;

FIG. 2 is an explosion diagram of the mobile charging device shown in FIG. 1;

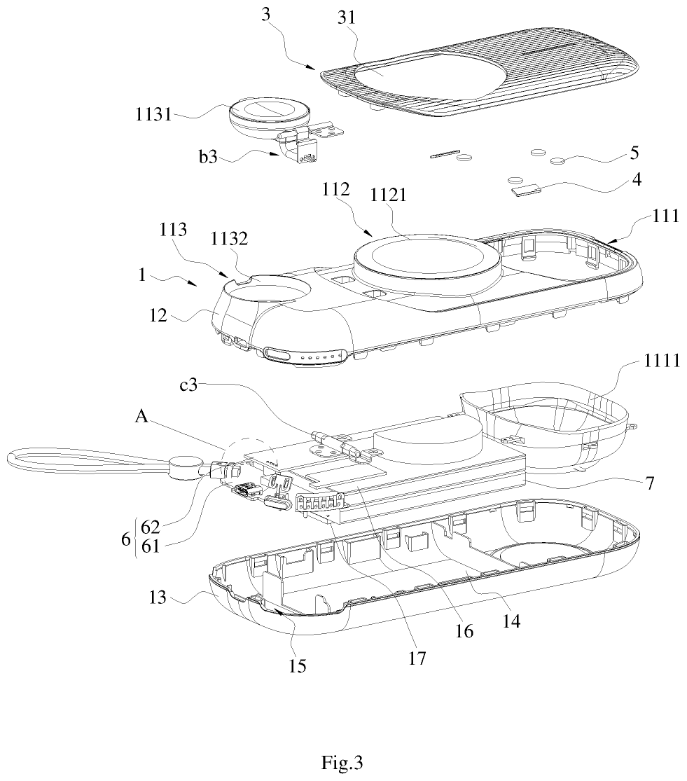

FIG. 3 is another explosion diagram of the mobile charging device shown in FIG. 1;

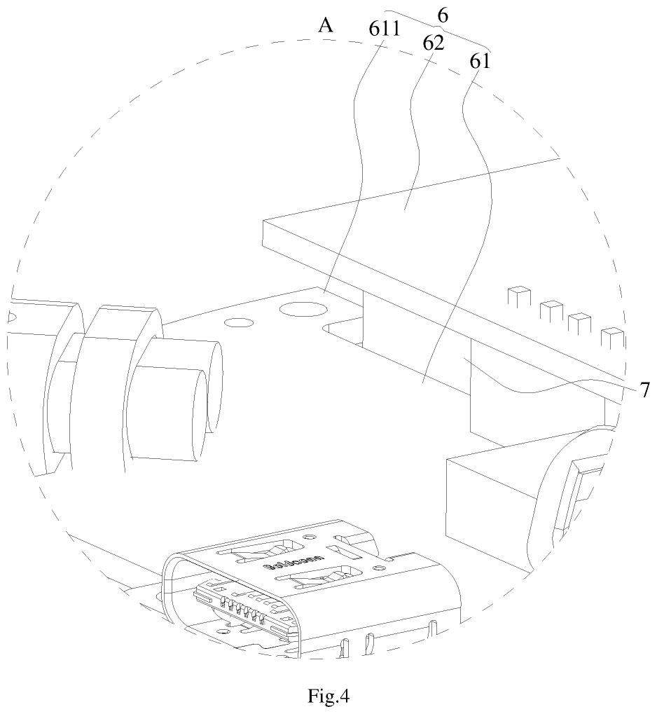

FIG. 4 is an enlarged view of the mobile charging device shown in FIG. 3 at A;

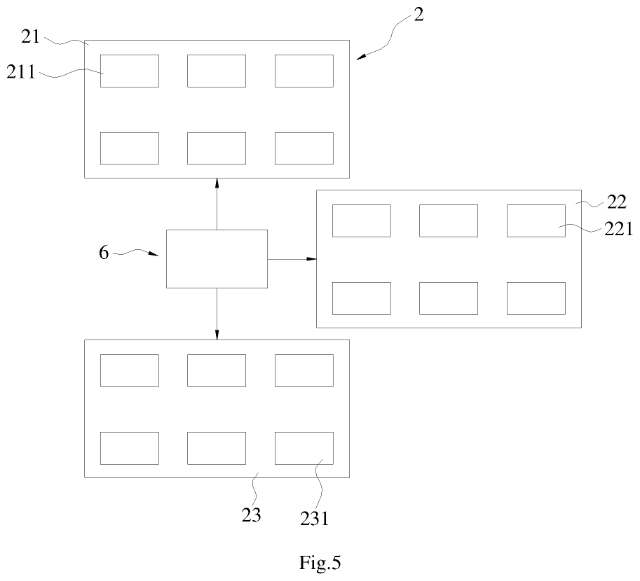

FIG. 5 is a structural schematic diagram of a charging assembly and an electronic control assembly in some preferred embodiments of the invention;

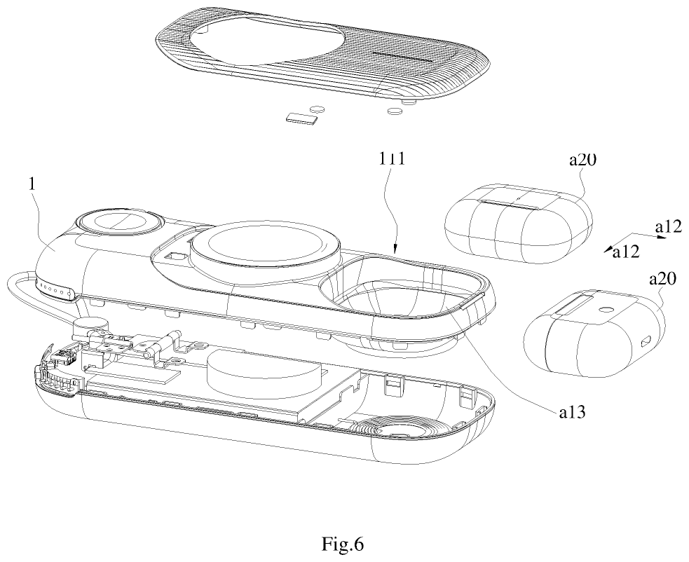

FIG. 6 is a structural schematic diagram of the mobile charging device in the second preferred embodiment of the invention;

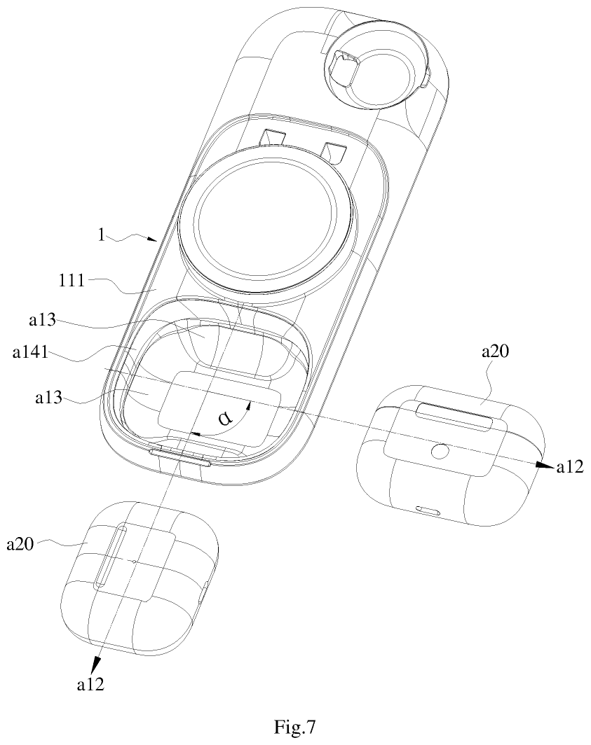

FIG. 7 is a partial structural diagram of the mobile charging device shown in FIG. 6;

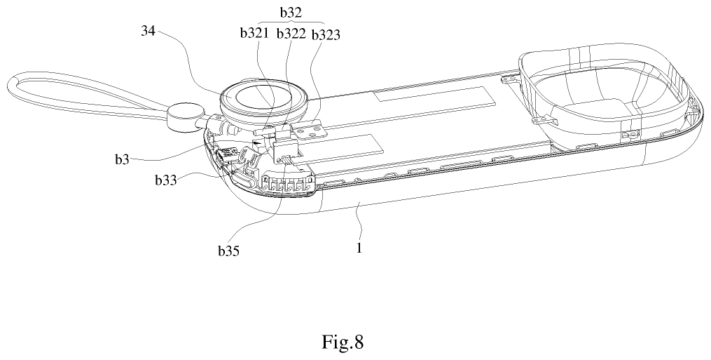

FIG. 8 is a structural schematic diagram of the mobile charging device in the third preferred embodiment of the invention;

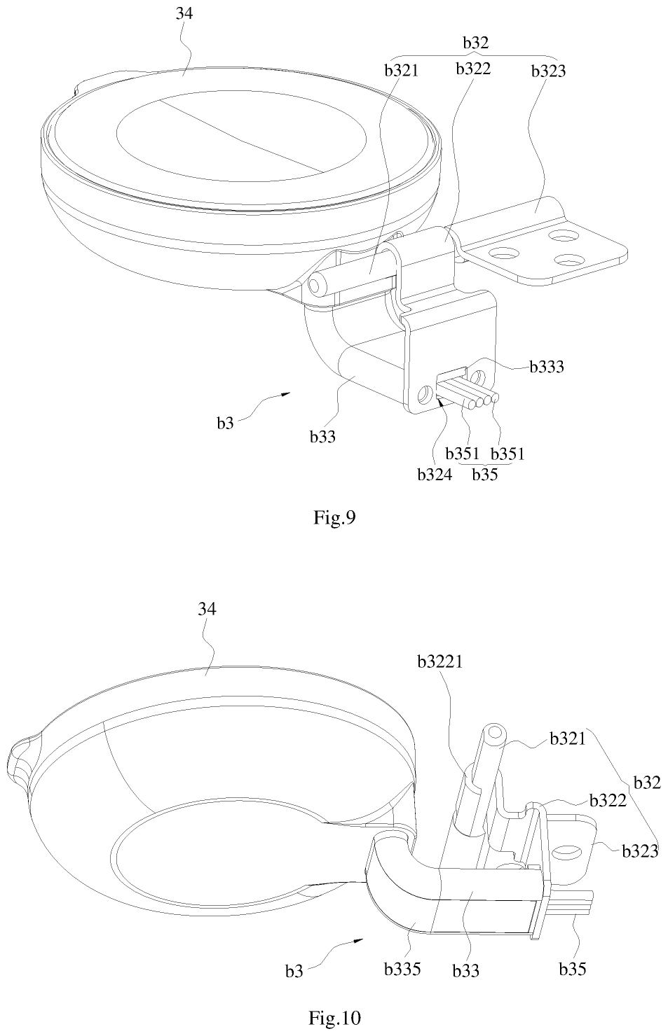

FIG. 9 is a partial structural diagram of the mobile charging device shown in FIG. 8;

FIG. 10 is a schematic view of the structure of the mobile charging device shown in FIG. 9 from another angle;

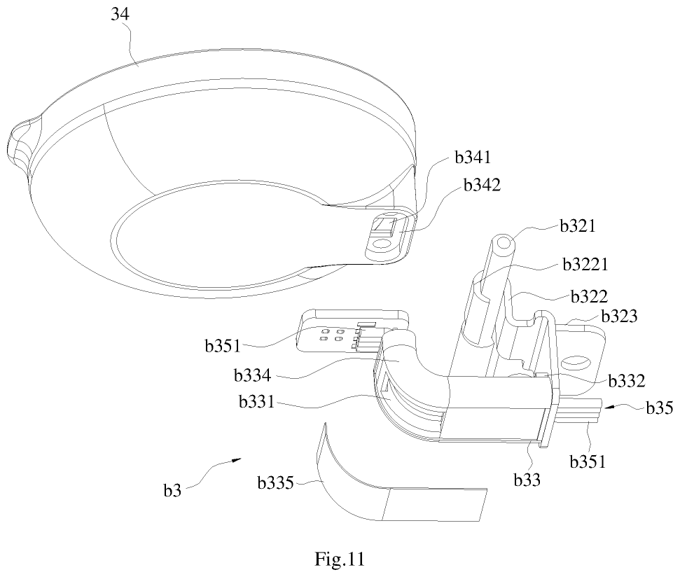

FIG. 11 is an explosion diagram of the mobile charging device shown in FIG. 10;

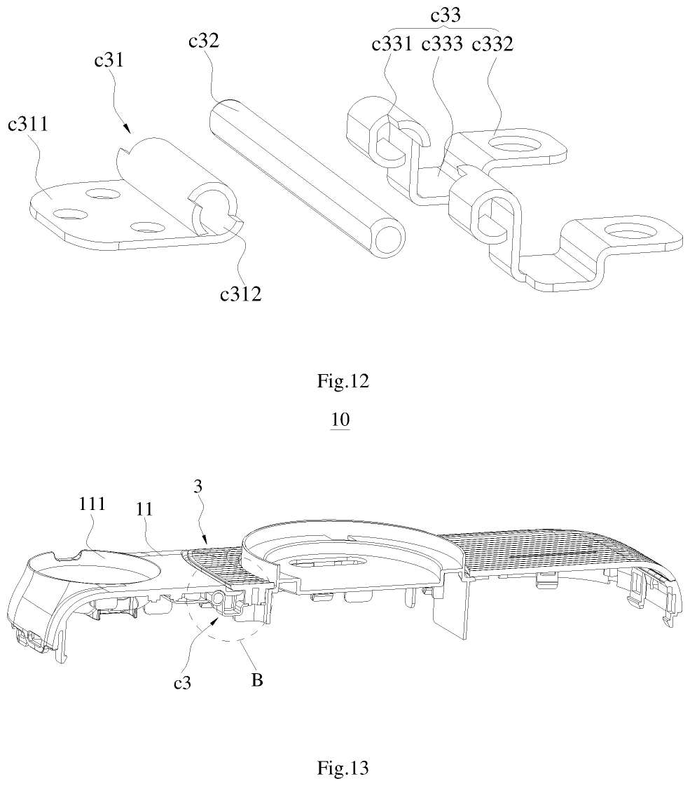

FIG. 12 is a structural schematic diagram of the mobile charging device in the fourth preferred embodiment of the invention;

FIG. 13 is a sectional view of a part of the structure of the mobile charging device in the fourth preferred embodiment of the invention;

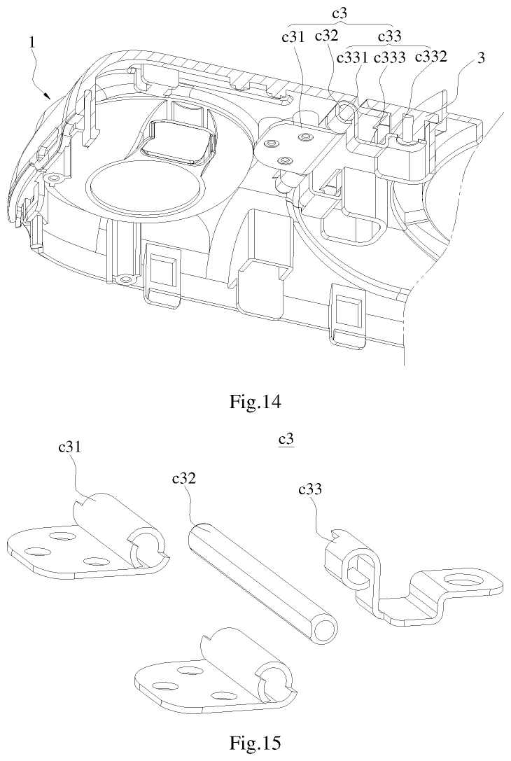

FIG. 14 is a schematic diagram of the broken structure of the partial structure of the mobile charging device in the fourth preferred embodiment of the invention;

FIG. 15 is an enlarged view of the mobile charging device shown in FIG. 13 at B;

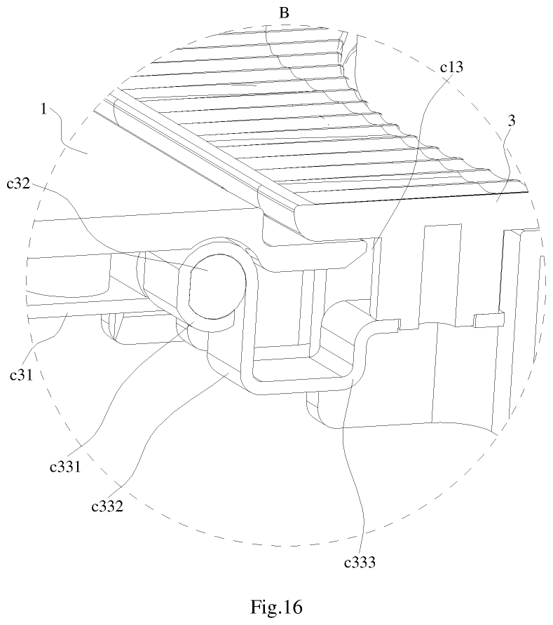

FIG. 16 is a structural schematic diagram of the mobile charging device in the fifth preferred embodiment of the invention.

### DETAILED DESCRIPTION OF THE INVENTION

### Embodiments of the Invention

In order to have a clearer understanding of the technical features, purpose and effect of the invention, the specific implementation mode of the invention is described in detail with reference to the attached drawings.

FIG. 1 shows a mobile charging device 10 in some preferred embodiments of the present invention, and the mobile charging device 10 is used for charging one or more electrical devices. It will be understood that the electrical devices include various types of electrical products common in the related art such as earphones, mobile phones, watches, electronic pens or remote controls and the like. Of course, the same type of electrical devices can also have different sizes and specifications.

As shown in FIGS. 2 to 5 the mobile charging device 10 comprises a housing assembly 1 and a charging assembly 2; the housing assembly 1 has an outer surface 11, on which a plurality of first charging positions 111 and a plurality of second charging positions 112 are arranged, and the first charging positions 111 and the second charging positions 112 are respectively used for limiting electrical devices;

The charging assembly 2 comprises a plurality of first charging modules 21 and a plurality of second charging modules 22; Each first charging module 21 is arranged in each first charging position 111 one by one, and each second charging module 22 is arranged in each second charging position 112 one by one; The first charging module 21 is used for charging the electrical device in the first charging position 111, and the second charging module 22 is used for charging the electrical device in the second charging position 112.

It can be understood that the housing assembly 1 serves to protect and accommodate the remaining parts; the charging assembly 2 is used for charging the electrical device.

The outer surface 11 may refer to the outer surface of the housing assembly 1 on which each first charging position 111 and each second charging position 112 are located, i.e. each first charging position 111 and each second charging position 112 are located on the surface of the housing assembly 1; Of course a cover plate or the like that can shield all or part of a first charging position 111 and a second charging position 112 may be provided on the housing assembly 1.

A first charging position 111 and a second charging position 112 may each be defined by a tank body, a hole body or other limiting structure, or may not have an obvious boundary, etc., and may only be used for the division of charging pertinence, etc. The structures of each charging position may be the same or different, depending on the type and shape specification of the electrical device for charging pertinently. Both a first charging position 111 and a second charging position 112 can hold and limit the electrical device through a tank body, a hole body or a cavity in the charging position, and can also limit the position of the electrical device by means of plug-in, buckle, magnetic attraction, screw connection or pressure holding fixation.

The number of the first charging modules 21 is set equal to the number of the first charging positions 111, the number of the second charging modules 22 is set equal to the number of the second charging positions 112, and each charging module may be configured to be able to operate independently, that is, only a required part of the charging module may be turned on; For example, only one or a part of a first charging module 21 is turned on, only one or a part of the second charging module 22 is turned on, and part of the first charging module 21 and part of the second charging module 22 are turned on simultaneously.

It can also be understood that the charging power of each charging module can be the same or different for charging electrical devices with different charging power requirements in different charging positions. For example, some charging modules are used to adapt to the charging power requirements of mobile phones, some charging modules are used to adapt to the charging power requirements of watches, and so on.

Preferably, there is no intersection between a first charging position 111 and a second charging position 112, between each first charging position 111, and between each second charging position 112. It can be understood that in the case where the respective charging positions do not intersect each other on the outer surface 11, the respective charging positions cannot interfere with each other when accommodating respective electrical devices, thereby enabling the mobile charging device 10 to charge a plurality of electrical devices of the same or different types at the same time. It should be noted that the same type of electrical devices can also have different specifications or charging power requirements. Different types of electrical devices can also have the same specifications or charging power requirements.

Further, the outer surface 11 may refer to one of the outer surfaces of the housing assembly 1, on which each charging position is located, that is, the electrical devices are placed on the surface for charging. It is convenient for users to complete the operation on the same side, and improves the convenience of using the product.

As shown in FIGS. 2, 3 and 5, in some embodiments, the outer surface 11 is further provided with a plurality of third charging positions 113, and the third charging positions 113 are used for limiting the electrical device; The charging assembly 2 also comprises a plurality of third charging modules 23, each of which is arranged in each third charging position 113 one by one, and a third charging module 23 is used for charging the electrical device in a third charging position 113.

It can be understood that a third charging position 113 does not intersect with a first charging position 111 and a second charging position 112 at the position where a first charging position 111, a second charging position 112 and a third charging position 113 are installed, so that a first charging position 111, a second charging position 112 and a third charging position 113 can simultaneously accommodate electrical devices, so that the mobile charging device 10 can simultaneously charge a plurality of electrical devices. The number of the third charging modules 23 is set to equal the number of the third charging positions 113, and each third charging position 113 is provided with a third charging assembly 23.

It is also understood that a third charging position 113 may accommodate and define the electrical device through a tank body, a hole body or a cavity in the charging position, and may also define the position of the electrical device by means of plug-in, buckle, magnetic attraction, screw connection or press-hold fixation.

Further, the types or sizes of the electrical devices specifically defined by a third charging position 113, a first charging position 111 and a second charging position 112 are all different, so as to limit the accommodation of different types of products.

As shown in FIGS. 2 and 3, in some embodiments, the outer surface 11 is provided with a first charging position 111, a second charging position 112, and a third charging position 113. It can be understood that the number of the first charging position 111, the second charging position 112, and the third charging position 113 are all set to one, and the electrical devices defined by the first charging position 111, the second charging position 112, and the third charging position 113 are different.

Specifically, the structure or construction of each charging position can be set according to the different sizes of the electrical devices, for example, the electrical devices with different sizes are placed in different charging positions to be limited and charged; Of course, each charging position can also be set according to the type of electrical device.

As shown in FIGS. 2 and 3, in some embodiments, an earphone box storage tank 1111 for accommodating the earphone box is provided in a first charging position 111, a boss 1121 for supporting a mobile phone is provided in a second charging position 112, and a watch charging element 1131 for supporting a watch is provided in a third charging position 113. A first charging module 21 comprises an earphone box wireless charging module 211 arranged in a first charging position 111, a second charging module 22 comprises a mobile phone wireless charging module 221 arranged in a second charging position 112, and a third charging module 23 comprises a watch wireless charging module 231 arranged in a watch charging element 1131.

It can be understood that the electrical device comprises an earphone box for storing the earphone and charging the earphone; the electrical devices also include mobile phones and watches. Of course, the electrical devices can also include other types of components or electronic products such as terminal equipment.

The earphone box storage tank 1111 is used for accommodating an earphone box. When an earphone box is placed in an earphone box storage tank 1111, the earphone box wireless charging module 211 charges the earphone box placed in the earphone box wireless charging module 211. The boss 1121 is used for supporting the mobile phone. When a mobile phone is placed on a boss 1121, the mobile phone wireless charging module 221 can wirelessly charge the mobile phone. A watch charging element 1131 is used for supporting a watch. When a watch is placed on a watch charging element 1131, the watch wireless charging module 231 will wirelessly charge the watch. Each charging module may be provided inside the housing assembly 1, and may be provided at the bottom, side or other positions of each charging position. It should be noted that each wireless charging module comprises a coil, which can generate a predetermined magnetic field when it is energized. When receiving the magnetic field energy, the electrical device converts it into electric energy and stores it to achieve the purpose of charging.

As shown in FIG. 2 and FIG. 3, in some embodiments, a third charging position 113 is provided with a receding groove 1132, the watch charging element 1131 is movably connected with the housing assembly 1, and the receding groove 1132 is used for accommodating the watch charging element 1131.

It can be understood that a receding groove 1132 is used for accommodating and protecting the watch charging element 1131 when the watch charging element 1131 is not in use, and preventing a watch charging element 1131 from forming an excessive protrusion amount on the housing assembly 1 when the watch charging element 1131 is not in use. a watch charging element 1131 is movably connected with the housing assembly 1, so that the watch charging element 1131 can be upright or nearly upright on the housing assembly 1, so that the watch band on the watch needing to be charged can bypass the watch charging element 1131 from both sides, and the watch band can be prevented from being stuck or restricted in other positions, thus ensuring that the watch can be accurately placed on the watch charging element 1131 for charging. The watch charging element 1131 and the housing assembly 1 may be configured as a rotational connection or a sliding connection, and may be connected by a structure such as a rotation shaft or a slide rail.

As shown in FIGS. 1 to 3, in some embodiments, the mobile charging device 10 further comprises a cover plate 3 provided on the housing assembly 1, and the cover plate 3 is provided with an avoidance hole 31; and the cover plate 3 is used for detachable cover on the outer surface 11, so that the cover plate 3 shields or exposes the first charging position 111; an avoidance hole 31 is used for exposing a second charging position 112 on the cover plate 3.

It can be understood that the cover plate 3 and the mobile charging device 10 may be configured with a rotational connection, a sliding connection, a detachable connection, etc. Specifically, the rotational connection may be realized by a rotation shaft connection, the sliding connection may be realized by a groove rail or a slide rail structure, and the detachable connection may be realized by a plug-in or a snap-in structure.

It can also be understood that when the cover plate 3 is properly fitted to the housing assembly 1, it can prevent an electrical device already limited in a first charging position 111 from being removed; Secondly, an avoidance hole 31 is used for enabling a second charging position 112 to remain exposed when the cover plate 3 is closed, thereby preventing the cover plate 3 from interfering with the second charging position 112.

As shown in FIGS. 2 and 3, in some embodiments, the mobile charging device 10 further comprises a cover magnetic attraction part 4 and a plurality of soft rubber pads 5; The cover magnetic attraction part 4 is arranged on the housing assembly 1 or the cover plate 3, the cover magnetic attraction part 4 is used for detachable absorbing and fixing the cover plate 3, the soft rubber pads 5 are arranged on the outer surface 11 or the cover plate 3, and at least part of the soft rubber pads 5 are used for contacting with the cover plate 3 and the electrical devices in a first charging position 111 respectively.

It can be understood that the cover magnetic attraction part 4 is used for absorbing and fixing the cover plate 3. In particular, the cover magnetic attraction part 4 can be arranged on the cover plate 3 and the housing assembly 1 respectively at the same time, and the cover magnetic attraction part can also be arranged on one of the housing assembly 1 and the cover plate 3, and a metal member can be arranged on the other of the two; In this way, the cover plate 3 is prevented from coming out of the housing assembly 1 in the closed state. The soft rubber pads 5 are used for cushioning the impact force of the cover plate 3 acting on the electrical device in a first charging position 111 when the cover plate 3 is closed. Further, all the soft rubber pads 5 can be symmetrically distributed.

As shown in FIGS. 3 to 5, in some embodiments, the mobile charging device 10 further comprises an electronic control assembly 6 and a battery 7; the electronic control assembly 6 is used for controlling the operation of the charging assembly 2 and the battery 7 used for supplying electric energy to the charging assembly 2. The electronic control assembly 6 comprises a first circuit board 61 and a second circuit board 62 connected with each other, and the battery 7 is connected with the electronic control assembly 6; The housing assembly 1 comprises an upper housing 12 and a lower housing 13 connected with each other, and the upper housing 12 and the lower housing 13 together define an accommodation space 14;

It can be understood that both the first circuit board 61 and the second circuit board 62 play a role in controlling and transferring current. The upper housing 12 and the lower housing 13 can be connected by means of plug-in, snap-in, screw-screw locking or the like. The accommodation space 14 is used for mounting and accommodating other devices, components or mechanisms such as for example for accommodating the battery 7.

The battery 7 is disposed in the accommodation space 14. The end of the battery 7 and the inner wall of the accommodation space 14 together define an installation position 15. The first circuit board 61 is disposed in the installation position 15, and the second circuit board 62 is disposed between the battery 7 and the inner wall of the accommodation space 14. It can be understood that when the space of the installation position 15 is utilized, it is possible to avoid further adding components at the position already occupied by the battery 7, thus avoiding excessive thickness of the product and improving the overall compactness of the product.

As shown in FIG. 3, in some embodiments, the housing assembly 1 further comprises an upper cushioning member 16 disposed between the battery 7 and the upper housing 12, and a lower cushioning member 17 disposed between the battery 7 and the lower housing 13. It can be understood that the upper cushioning member 16 and the lower cushioning member 17 are used to protect the battery 7 from two opposite sides, respectively, to prevent the battery 7 from being damaged by pressure and to improve the durability of the product.

As shown in FIG. 4, in some embodiments, the first circuit board 61 is provided with two fixing frames 611 for inserting between the battery 7 and the inner wall of the accommodation space 14 from opposite sides.

It can be understood that the two fixing frames 611 are extended so that the battery 7 can be clamped from two opposite positions, so that the first circuit board 61 can be fixed by the battery 7, and the first circuit board 61 can be prevented from swinging, shaking or the like in the installation position 15.

As shown in FIGS. 6 and 7, in some embodiments of the mobile charging device 10, at least two storage directions a12 are arranged in the first charging position 111, and storage grooves a13 are corresponding to each storage direction a12. The contours of each storage groove a13 are the same or different, and a storage groove a13 is used for storing electrical device. A first charging module 21 is used for wireless charging the electrical devices in a storage groove 13.

It can be understood that the battery 7 is used for storing electric energy and for charging the electrical device when needed; a first charging module 21 is used for wirelessly charging the power device. A storage direction a12 refers to the placement direction of the electrical device, and the electrical device placed along the storage direction a12 can smoothly fall into a corresponding storage groove a13 to be accommodated and fixed, thereby charging. Each of the storage grooves a13 is used for storing electrical devices.

It should be noted that a storage groove a13 may be directly opened on the housing assembly 1, or may be defined on the housing assembly 1throgh other parts or structures and like. When the contours of each storage groove a13 are set to be different, it means that the contour specifications of the electrical devices corresponding to each storage groove a13 are different, in other words, a single charging position can store, fix and charge products with different contour specifications. When the contours of each storage groove 13 are set to be the same, the electrical device to be charged can be accommodated and fixed in each storage direction a12 when placed, thus avoiding the tedious alignment process of the user;

It should be further clarified that, When a plurality of storage grooves a13 are provided, firstly, the contours of each storage groove a13 may be set to be identical; Second, the contours of each of the storage grooves a13 may be set to be different; Third, the contours of some of the storage grooves a13 may be set to be identical, and the remaining storage grooves a13 may be set to be different or further set to be identical in the contours of some of the storage grooves 13 therein; Of course, the contour of each storage groove a13 can be flexibly set, and can be flexibly adjusted according to the application requirements.

As shown in FIGS. 6 and 7, the two storage directions a12 cross in some embodiments. It can be understood that one storage groove a13 is provided in one storage direction a12 so that the number of storage grooves a13 in the present embodiment is equal to the number of storage directions a12. The intersecting two storage directions a12 mean that the central axes of the two storage grooves a13 are perpendicular to each other.

It should be noted that although the two storage directions a12 crossed, the two storage grooves a13 can be communicated or not, and the positions of the two storage grooves a13 can be flexibly adjusted according to the application and design requirements. The angle formed by the intersection of the two storage directions a12 is an alpha angle shown in FIG. 7, and the alpha angle is a right angle.

As shown in FIGS. 6 and 7, in some embodiments, two storage directions a12 are provided within the first charging position 111, and the two storage directions a12 intersect at an acute angle.

Understandably, the two storage directions a12 mean that the number of the storage grooves a13 in the present embodiment is two. Compared with the arrangement mode of crossing, the technical proposal of the present embodiment is adopted to set the positions of the two storage grooves a13, so that the two storage grooves a13 can be arranged at a relatively close distance, and the space occupied by the two storage grooves a13 is reduced. The alpha angle formed by the intersection of the two storage directions a12 is an acute angle, and the smaller the alpha angle, the more the two storage grooves a13 tend to coincide completely.

As shown in FIGS. 6 and 7, in some embodiments, on the basis that two storage directions a12 are provided in the first charging position 111, the contours of the two storage grooves a13 are identical, the two storage grooves a13 communicate with each other, and the centers of the two storage grooves a13 overlap with each other.

Understandably, the contours of the two storage grooves a13 are identical, which means that the contour specifications of the electrical devices corresponding to the two storage grooves a13 are the same, so that an electrical device can be correctly accommodated and fixed only by aligning with one of the storage grooves a13, thus avoiding the tedious alignment for placing and accommodating.

As shown in FIGS. 6 and 7, in some embodiments, an electrical device comprises an earphone box a20 and each storage groove a13 is used for storing the earphone box a20. It can be understood that the earphone box a20 has a built-in battery and the earphone box a20 can charge the earphone stored therein.

As shown in FIGS. 6 and 7, in some embodiments, a first charging position 111 is provided with a plurality of storage directions a12, the centers of the storage grooves a13 coincide with each other, and the storage grooves a13 are symmetrically distributed with the center of the first charging position 111.

It can be understood that by increasing the number of the storage grooves a13, the types of fixed and charged electrical devices that can be pertinently accommodated by the mobile charging device 10 can be further improved, and the convenience of the user in positioning the electrical devices can be improved. The centers of each storage grooves a13 overlap with each other, that is, each storage grooves a13 are communicated with each other, so that the charging position all is prevented from occupying too much space and area due to the arrangement of a plurality of storage grooves a13, and the compactness is improved.

As shown in FIGS. 6 and 7, in some embodiments the groove wall of the earphone box storage groove 1111 is recessed in each housing direction a12 to form each housing groove a13. It can be understood that the earphone box storage groove 1111 is used for the electrical device to be charged to be placed in the first charging position 111 in advance so as to be correctly aligned and housed in the storage tank 13. A movable cover plate 3 selectively shields the earphone box storage groove 1111 and plays a protective role.

As shown in FIGS. 6 and 7, in some embodiments, a guide inclined surface a141 is provided on the groove wall of the earphone box storage groove 1111, and the guide inclined surface a141 is used for guiding the electrical device to correctly align the storage tank 13. It can be understood that the guide inclined surface a141 may be an inclined plane or a curved surface. Specifically, the invention can guide the electrical device to correct deviation to a correct storage direction a12 and then smoothly fall into the corresponding storage groove a13, thereby further improving the convenience of use.

As shown in FIGS. 3, 8 and 9, in some embodiments of the mobile charging device 10, the watch charging element 1131 is connected to the housing assembly 1 through a first rotating mechanism b3 for realizing the rotational connection between the watch charging element 1131 and the housing assembly 1.

As shown in FIGS. 8 to 11, a first rotating mechanism b3 comprises a rebound rotation device b32 arranged on the housing assembly 1, and an avoidance member b33 connected with the rebound rotation device b32; The watch charging element 1131 is connected to the rebound rotation device b32;

an avoidance member b33 is used for defining a non-deformable limiting channel b331 between the rebound rotation device b32 and the watch charging element 1131, and the limiting channel b331 is used for penetrating a connecting member b35 connecting the watch charging element 1131; The rebound rotation device b32 is used to drive the avoidance member b33 to reset and rotate, so that the avoidance member b33 drives the watch charging element 1131 to rotate and reset.

It can be understood that the rebound rotation device b32 is used to provide a force for driving the avoidance member b33 to rotate and reset. An avoidance member b33 is used to rotate synchronously with the watch charging element 1131. An avoidance member b33 may be made of metal hard plastic or the like as long as it has sufficient anti-deformation capability. A watch charging element 1131 is used to rotate to different positions relative to the housing assembly 1 for use by the user. A connecting member b35 is connected with the watch charging element 1131. A connecting member b35 comprises a plurality of wires b351. The connecting member b35 can also be configured to include other flexible and easily deformed components. All kinds of flexible or easily deformed components can be protected and limited in the limiting channel b331. The connecting member b35 in the limiting channel b331 will not be deformed. The connecting member b35 is prevented from being exposed between the housing assembly 1 and the watch charging element 1131 after deformation and occupying a certain space. The connecting member b35 is also prevented from being stuck in the housing assembly 1 or other positions after deformation, thus ensuring the rotation comfort and improving the matching tightness between the watch charging element 1131 and the housing assembly 1 after rotation reset.

It can also be understood that the non-deformable limiting channel b331 means that the avoidance member b33 itself is not deformable or subject to amplitude changes, so as to ensure that the internal limiting channel b331 is not deformed or excessively deformed. The limiting channel b331 can be defined by the avoidance member b33 alone or by the avoidance member b33 and other components, but it is necessary to ensure that all components will not be deformed and stuck in other positions during rotation.

It should be noted that, When a watch charging element 1131 is rotated, because the connecting member b35 is flexible and easily deformed and connected with the watch charging element 1131, the connecting member b35 will be pulled out from the housing assembly 1 under the drive of the watch charging element 1131, and in the process of pulling out and driving, the connecting member b35 will be stretched and straight, so that the stretched and straight connecting member b35 is easy to get stuck in the housing assembly 1 or other positions, first it is easy to get stuck, and Secondly, It is easy to strain the connecting member b35.

However, in the technical proposal, an avoidance member b33 itself does not deform or excessively deform during the rotation process, and an avoidance member b33 that does not deform can always remain unchanged in shape, length and other specifications during the rotation process, so that an avoidance member b33 will not be stuck in the housing assembly 1 or other positions, and a connecting member b35 in the limiting channel b331 defined by an avoidance member b33 can also remain unchanged;

To sum up, during the rotation process, a connecting member b35 and an avoidance member b33 can be prevented from being stretched straight between a watch charging element 1131 and the housing assembly 1, and the predetermined shape and length can always be maintained as much as possible, so that the stretched and straight connecting member b35 and the avoidance member b33 can be prevented from sticking to the housing assembly 1 or other positions.

It should also be noted that although a connecting member b35 can remain unchanged in a limiting channel b331, since an end of a connecting member b35 connected to the rotating member b34 will rotate along with a watch charging element 1131, the other positions of a connecting member b35 must have enough length for the connecting member b35 to rotate along with a watch charging element 1131, and the reserved length can be placed inside the housing assembly 1. Although the reserved length will be deformed, it will not be exposed outside the housing assembly 1 beyond the position of an avoidance member b33, and will not be stuck in the rotating position of the watch charging element 1131 on the housing assembly 1. On the other hand, it will not occupy the space between the housing assembly 1 and a watch charging element 1131.

Specifically, a rebound rotation device b32 can be configured to provide a force to drive an avoidance member b33 to rotate and reset at all times, so that an avoidance member b33 is always subjected to the force to rotate and reset, so that after a watch charging element 1131 has rotated and reset to a predetermined position on the housing assembly 1, it will always cling to the surface of the housing assembly 1 under the drive of the rotation and reset force, thus preventing a watch charging element 1131 from accidentally coming out, and further improving the fit tightness between a watch charging element 1131 and the housing assembly 1.

As shown in FIGS. 8 to 11, in some embodiments, a rebound rotation device b32 comprises a rotation shaft b321 provided on the housing assembly 1, and a reset member b322 sleeved on the rotation shaft b321; a reset member b322 is connected with a watch charging element 1131, and a reset member 322 is used for driving a watch charging element 1131 to rotate and reset.

It can be understood that a rotation shaft b321 serves to support a reset member b322 for driving a watch charging element 1131 to rotate and reset. A reset member b322 itself can be made of a material having a certain resilient property, and a reset member b322 itself has the ability of deformation reset. A reset member b322 may include a portion or portions the common deformable reset of which achieves the effect of driving the reset of the watch charging element 1131.

As shown in FIGS. 8 to 11, in some embodiments, a rebound rotation device b32 further comprises a fixing seat b323 arranged on the housing assembly 1, a fixing hole b3231 is arranged on the fixing seat b323, and a rotation shaft b321 is penetrated through a fixing hole b3231.

Understandably, a fixing seat b323 serves to fix the relative positions of a rotation shaft b321 and the housing assembly 1, and of course, also serves to prevent rotation of a rotation shaft b321, thereby preventing the position of a reset member b322 from shifting due to the rotation of a rotation shaft b321, thereby preventing a reset member b322 from having a rotational virtual position, and further preventing a watch charging element 1131 from being unable to obtain the rotational reset force provided by a rebound rotation device b32 when it is rotated to a partial position. A fixing hole b3231 is used for accommodating a rotation shaft b321. Specifically, the hole wall of a fixing hole b3231 and a rotation shaft 321 can be fixed by means of interference fit, welding, bonding, clamping and the like to prevent a rotation shaft b321 from rotating in a fixing hole b3231.

It can also be understood that a fixing seat b323 may not only be configured to be fixed to the housing assembly 1 by a threaded member, but also may be configured to be disposed on the housing assembly 1 by bonding, snapping, integral molding or the like.

As shown in FIGS. 9 to 11, in some embodiments, a reset member b322 is provided with a winding portion b3221 which is wound and fixed on a rotation shaft b321.

It can be understood that the relative positions of a winding portion b3221 and a rotation shaft b321 are fixed, and a rotation shaft b321 does not rotate in a winding portion b3221. During the rotation of a reset member b322, the reset member b322 is further wound on or loosened from a rotation shaft b321. However, regardless of whether a reset member b322 is continuously wound or gradually loosened with respect to a rotation shaft b321, a reset member b322 has a tendency of deformation recovery and always provides an acting force to drive an avoidance member b33 to reset.

As shown in FIGS. 9 to 11, in some embodiments, a rebound rotation device b32 is provided with a first wire passing hole b324 and a watch charging element 1131 is provided with a second wire passing hole b341. An avoidance member b33 is in contact with a rebound rotation device b32 and a watch charging element 1131, respectively, so that a limiting channel b331 is aligned and communicated with a first wire passing hole b324 and a second wire passing hole b341, respectively.

It can be understood that both a first wire passing hole b324 and a second wire passing hole b341 are used for passing through a connecting member b35, and a connecting member b35 located inside the housing assembly 1 can pass through a first wire passing hole b324 into a limiting channel b331, and then be installed along the side wall of the limiting channel b331, and then a connecting member b35 is passed through a second wire passing hole b341 and connected to a watch charging element 1131.

As shown in FIGS. 9 to 11, in some embodiments, a watch charging element 1131 is also provided with an accommodating slot b342, a second wire passing hole b341 is located in the accommodating slot b342, and an avoidance member 33 is inserted in the accommodating slot b342.

Understandably, an accommodating slot b342 is used for inserting one end of an avoidance member b33 therein, so that a connecting member b35 directly enters a watch charging element 1131 for connection after passing through the limiting channel b331, thus avoiding the exposure of a connecting member b35 and protecting a connecting member b35 to a certain extent.

As shown in FIGS. 9 to 11, in some embodiments, an avoidance member b33 is provided with an insertion limiting part b332 and an insertion positioning part b333; the insertion positioning part b333 is used for inserting into the rebound rotation device b32 so that a first wire passing hole b324 and a limiting channel b331 are aligned with a second wire passing hole b341, and an insertion limiting part b332 is used for abutting to a rebound rotation device 32 under the driving of an avoidance member b33.

Understandably, a hole or a slot for inserting an insertion positioning part b333 is provided in a rebound rotation device b32. In the process of assembling a rebound rotation device b32 and an avoidance member b33, an insertion positioning part b333 is correctly aligned and inserted, so that the assembly of an avoidance member b33 and a rebound rotation device b32 can be completed quickly and accurately, and the assembly efficiency is improved.

An insertion limiting part b332 is used for abutting a rebound rotation device b32 after an insertion positioning part b333 is inserted into a rebound rotation device b32 at a predetermined depth, so as to prevent an avoidance member b33 from going too deep or directly through a rebound rotation device b32. Specifically, the insertion position of an insertion positioning part 333 may be set on a reset member 322.

As shown in FIGS. 9 to 11, in some embodiments an avoidance member b33 is provided with a bending section b334 and a limiting channel b331 is located within an avoidance member b33 and extends along a bending section b334.

It can be understood that a bending section b334 is arranged to avoid a sufficient space between an avoidance member b33 and the housing assembly 1 to prevent the avoidance member b33 from being stuck on the housing assembly 1 during rotation.

It should be noted that, a bending section b334 is arranged so that the position of a bending section b334 will rotate with a larger radius, so that the bending section b334 can be prevented from being stuck in the notch or other positions on the basis of the notch for an avoidance member b33 to pass through in the housing assembly 1.

As shown in FIGS. 10 and 11, in some embodiments, an avoidance member b33 is provided with a cover body b335 which together with the avoidance member b33 defines a limit channel b331.

Understandably, when a cover body b335 is not assembled, a limit channel b331 is open, and the open position can be used for a user to install and set a connecting member b35. Especially when a limit channel b331 has a bent position, a connecting member b35 can be directly set through the open position, thus improving the assembly convenience.

As shown in FIG. 3, in some embodiments of the mobile charging device 10, a cover plate 3 is connected to the housing assembly 1 by a second rotating mechanism c3; a second rotating mechanism c3 is used for supporting a cover plate 3 to rotate on the housing assembly 1 so as to enable a cover plate 3 to open or shield a first charging position 111 during movement.

As shown in FIGS. 12 to 15, a second rotating mechanism c3 comprises a self-reset assembly c31 arranged on the housing assembly 1, a shaft body c32 arranged on a self-reset assembly c31, and a rigid extension connection c33 arranged on a shaft body 32, wherein the rigid extension connection c33 connects the housing assembly 1;

It can be understood that, a self-reset assembly c31 has the deformation reset capability and plays a role in driving a shaft body c32 to reset together; Of course, in some embodiments, a self-reset assembly c31 may only have the function of fixing a shaft body c32, which is mainly used to prevent the shaft body 32 from deflecting, etc. However, if a self-reset assembly c31 is inevitably driven by a shaft body c32 and deformed, the self-reset assembly c31 will also drive a shaft body c32 to rotate and reset. A shaft body c32 functions to support a rigid extension connection c33 to rotate that is the rigid extension connection c33 can only rotate about a shaft body c32. A rigid extension connection c33 itself has a certain strength and can be made of a material which is not easy to bend. A rigid extension connection c33 transmits a torque, and the relative positions of both ends of a rigid extension connection 33 can be fixed.

A self-reset assembly c31 is used for providing a torsion force to drive a shaft body c32 to rotate and reset, thereby providing a cover force to drive a cover plate 3 to rotate in the direction of covering the outer surface 11; When a cover plate 3 rotates away from the outer surface 11 against the cover force, a rigid extension connection c33 is driven by the cover plate 3 to rotate, so that the rigid extension connection c33 drives a shaft body c32 to rotate on a self-reset assembly c31, and further drives the self-reset assembly c31 to deform.

Understandably, a cover plate 3 can be rotated in the direction of covering the outer surface 11, and a self-reset assembly c31 is used for driving a shaft body c32 to rotate in a predetermined direction, so that the self-reset assembly c31 drives a rigid extension connection c33 to rotate, and then the rigid extension connection c33 drives the cover plate 3 to rotate in the direction of covering the outer surface 11; a rigid extension connection c33 connects a shaft body c32 with a cover plate 3, and under the condition that the rigid extension connection c33 itself has certain rigidity, the rotation of the cover plate 3 will drive a shaft body c32 to rotate, on the contrary, when a shaft body c32 is driven by torsion to reset and rotate, it will drive the movable parts to reset and cover;

It should be noted that the connection and fit relationship between a shaft body c32 and a self-reset assembly c31 can be configured in the following embodiments: first, under the condition that a cover plate 3 has been covered in place on the outer surface 11, the self-reset assembly c31 will also provide a certain torque to the shaft body c32, so that the cover plate 3 can always receive a certain cover force and improve the cover tightness of the cover plate 3; Second, in the case where the cover plate 3 has been closed in place on the outer surface 11, the torque provided by the self-reset assembly c31 to the shaft body c32 is zero or nearly zero, thereby preventing fatigue of the self-reset assembly c31 due to holding the deformation for too long, and improving the durability of the self-reset assembly c31.

It can also be understood that, a cover plate 3 can be rotated in a direction away from the outer surface 11. During this rotation, the cover plate 3 will drive a rigid extension connection c33 to rotate synchronously. At this time, the rigid extension connection c33 will rotate around the position of a shaft body c32, and the shaft body c32 will also be twisted under the drive of the rigid extension connection c33, thus driving a self-reset assembly c31 to deform. During the deformation process, a self-reset assembly c31 has a torsion force that drives a shaft body c32 to rotate and reset, so that a cover plate 3 can be quickly closed to the outer surface 11 after release, which is very fast.

In addition to the above, it should also be noted that the position of a shaft body c32 is maintained on the housing assembly 1 due to a self-reset assembly c31, and the shaft body c32 only rotates on the housing assembly 1. On this basis, a shaft body c32 is connected with a cover plate 3 through a rigid extension connection c33, so that a shaft body c32 can support a cover plate 3 to rotate even if it only rotates on the housing assembly 1;

Thus, a shaft body c32 can be arranged in the housing assembly 1, that is, it can be fixed to the housing assembly 1 without occupying the space on the outer surface 11 of the housing assembly 1, thereby improving the surface flatness of the product. Contact of contaminants outside the housing assembly 1 with a shaft body c32 is also prevented and the durability of the product is improved.

As shown in FIGS. 12 to 16, in some embodiments, a self-reset assembly c31 comprises a mounting plate c311 arranged on the housing assembly 1, the edge of the mounting plate c311 is rolled up and enclosed into a mounting slot c312, and a shaft body c32 is fixed through the mounting slot c312.

It can be understood that, a mounting plate c311 itself may be made of a material having a certain reset effect, and the mounting plate c311 may be fixed to the housing assembly 1 by a threaded fastener or a snap connector or the like, and may also be mounted by an adhesive manner. The slot wall of a mounting slot c312 is used to support each other with a shaft body 32.

It should be noted that, a tangent plane can be added in a mounting slot c312, and a corresponding notch can be added in a shaft body c32. In the process of a shaft body c32 penetrating a mounting slot c312, the tangent plane and the notch will contact each other, so that the slip phenomenon between the shaft body c32 and the mounting slot c312 can be prevented, and the bite force between the shaft body c32 and the mounting slot c312 can be increased.

Further, a shaft body 32 and a rigid extension connection 33 may be provided with a structure in which the tangent plane and the notch are adapted to each other similar to the above-described embodiment to avoid slippage between the shaft body 32 and the rigid extension connection 33.

As shown in FIGS. 12 to 16, in some embodiments the rigid extension connection c33 comprises a first end c331 connecting a shaft body c32, a second end c332 connecting a cover plate and an intermediate connecting part c333 connecting the first end c331 and the second end c332.

It can be understood that, a first end c331 can be connected to a shaft body c32 in a winding and fixing manner, and a second end c332 can also be connected to a cover plate 3 in a winding and fixing manner; Of course both the first end c331 and the second end c332 may also be locked to a predetermined installation position by a threaded fastener; an intermediate connecting part c333 serves to maintain the relative position of a first end c331 and the second end c332 as much as possible.

It should be noted that, the specific length and contour direction of an intermediate connecting part c333 need to be set according to the specific structure inside the product, so as to avoid collision or sticking between the intermediate connecting part c333 and foreign objects during rotation and ensure the rotation fluency of the rigid extension connection c33. The thickness of the intermediate connection c333 can be flexibly set and it is preferable to maintain sufficient rigidity.

In some embodiments, the intermediate connecting part c333 is in a straight plate shape. It can be understood that the straight-plate-shaped intermediate connecting part c333 and a rigid extension connection c33 can connect the first end c331 and the second end c332 in a shorter path, that is, can connect the cover plate 3 and the shaft body c32 in a shorter path, thus avoiding occupying too much internal space of the housing assembly 1 and improving the compactness of the product to a certain extent.

As shown in FIGS. 12 to 16, in some embodiments the intermediate connecting part c333 is L-shaped or U-shaped. It can be understood that the L-shaped or U-shaped intermediate connecting part c333 means that the intermediate connecting part c333 has a certain bending direction, which can avoid a certain space to avoid collision and jamming between the intermediate connecting part c333 and the housing assembly 1 or other parts during rotation, for example, to avoid space for the elements or components used for forming the slot body on the housing assembly 1, and to avoid the normal rotation restriction of the rigid extension connecting part c33.

As shown in FIGS. 12 to 16, in some embodiments, the second rotating mechanism c3 comprises two rigid extension connections c33 that respectively connect both ends of the shaft body c32, the self-reset assembly c31 is located between the two rigid extension connections c33, and the self-reset assembly c31 is connected to an intermediate position of the shaft body c32.

It can be understood that, by setting the number of self-reset assembly c31 to one, the production cost of the product can be reduced, and the self-reset assembly c31, which are already large in volume, can also be prevented from occupying too much space in the housing assembly 1; The arrangement of two rigid extension connections c33 means that there are two connection positions between the cover plate 3 and the second rotating mechanism c3, thus improving the connection stability and reliability.

As shown in FIG. 16, in some embodiments the second rotating mechanism c3 comprises two self-reset assemblies c31 respectively connecting both ends of the shaft body c32 with a rigid extension connection c33 disposed between the two self-reset assemblies c31 and connected to an intermediate position of the shaft body c32.

It can be understood that, the arrangement of the two self-reset assemblies c31 can increase the torsion force supplied to the shaft body c32, increase the closing force of the cover plate 3, improve the closing tightness of the cover plate 3 on the housing assembly 1, and achieve better protection effect.

As shown in FIG. 15, in some embodiments, the housing assembly 1 is provided with a through hole c13, and the rigid extension connection c33 is used to penetrate through the outer surface 11 under the drive of the cover plate 3, and the rigid extension connection c33 is also used to reset to the housing assembly 1 under the drive of the shaft body c32.

It can be understood that a through hole c13 is used for a rigid extension connection c33 to pass through a cover plate 3. In the process of rotating the cover plate 3, the second end c332 of the rigid extension connection c33 is connected with the cover plate 3. When the rotation amplitude of the cover plate 3 is further increased, the second end c332 will inevitably be driven to contact the housing assembly 1, and the opening of the through hole c13 can prevent the second end c332 from being stuck on the housing assembly 1.

The mobile charging device of the invention has at least the following beneficial effects:

The mobile charging device of the invention relates to the technical field of charging devices. By arranging a first charging position and a second charging position on the outer surface of a housing assembly, and arranging a first charging module in the first charging position and a second charging module in the second charging position, the electrical devices of different types or the same type can be respectively accommodated in the first charging position and the low charging position, thus enhancing the charging universality of the mobile charging device.

The above embodiment is only for explaining the technical conception and characteristics of the invention, and the purpose is to enable people familiar with the technology to understand the contents of the invention and implement the invention accordingly, without limiting the protection range of the invention. Any equal changes and modifications made with the scope of the claims of the invention shall belong to the scope of the claims of the invention.

What is claimed is:

1. A mobile charging device, which is used for charging electrical devices and characterized by comprising a housing assembly and a charging assembly;
the housing assembly has an outer surface, and the outer surface is provided with a plurality of first charging positions and a plurality of second charging positions; the first charging positions and the second charging positions are respectively used for limiting the electrical device;
the charging assembly comprises a plurality of first charging modules and a plurality of second charging modules; each of the first charging modules is one-to-one correspondingly arranged in each of the first charging positions, and each of the second charging modules is one-to-one correspondingly arranged in each of the second charging positions;
the first charging module is used for charging the electrical device in the first charging position, and the second charging module is used for charging the electrical device in the second charging position.

2. The mobile charging device according to claim 1, wherein the outer surface is also provided with a plurality of third charging positions, and the third charging positions are used for limiting the electrical device;
the charging assembly also comprises a plurality of third charging modules, each of which is arranged in each of the third charging positions one by one, and the third charging module is used for charging the electrical device in the third charging position.

3. The mobile charging device according to claim 2, wherein the outer surface is provided with a first charging position, a charging position and a third charging position.

4. The mobile charging device according to claim 2, wherein the first charging position is provided with an earphone box storage tank for accommodating an earphone box, the second charging position is provided with a boss for supporting a mobile phone, and the third charging position is provided with a watch charging element for supporting a watch;
the first charging module comprises an earphone box wireless charging module arranged in the first charging position, the second charging module comprises a mobile phone wireless charging module arranged in the second charging position, and the third charging module comprises a watch wireless charging module arranged in the watch charging element.

5. The mobile charging device according to claim 4, wherein the third charging position is provided with a receding groove, the watch charging element is movably connected with the housing assembly, and the receding groove is used for accommodating the watch charging element.

6. The mobile charging device according to claim 1, wherein the mobile charging device further comprises a cover plate arranged on the housing assembly, and the cover plate is provided with a position avoidance hole;
wherein, the cover plate is used for detachable cover on the outer surface, so that the cover plate shields or exposes the first charging position; the position avoidance hole is used for exposing the second charging position on the cover plate.

7. The mobile charging device according to claim 6, wherein the mobile charging device further comprises a cover magnetic attraction part and a plurality of soft rubber pads;
the cover magnetic attraction part is arranged on the housing assembly or the cover plate, the cover magnetic attraction part is used for detachable adsorbing and fixing the cover plate, the soft rubber pads are arranged on the outer surface or the cover plate, and at least part of the soft rubber pads are used for respectively contacting with the cover plate and the electrical device in the first charging position.

8. The mobile charging device according to claim 1, wherein the mobile charging device further comprises an electronic control assembly and a battery, and the electronic control assembly comprises a first circuit board and a second circuit board connected with each other, and the battery is connected with the electronic control assembly;
the housing assembly comprises an upper housing and a lower housing connected with each other, and the upper housing and the lower housing together define an accommodation space;
the battery is arranged in the accommodation space, the end of the battery and the inner wall of the accommodation space together define an installation position, the first circuit board is arranged in the installation position, and the second circuit board is arranged between the battery and the inner wall of the accommodation space.

9. The mobile charging device of claim 8, wherein the housing assembly further comprises an upper cushioning member disposed between the battery and the upper housing, and a lower cushioning member disposed between the battery and the lower housing.

10. The mobile charging device according to claim 8, wherein two fixing frames are provided on the first circuit board and the fixing frames are used for inserting between the battery and the inner wall of the accommodation space from opposite sides.

11. The mobile charging device according to claim 3, wherein the first charging position is provided with an earphone box storage tank for accommodating an earphone box, the second charging position is provided with a boss for supporting a mobile phone, and the third charging position is provided with a watch charging element for supporting a watch;
the first charging module comprises an earphone box wireless charging module arranged in the first charging position, the second charging module comprises a mobile phone wireless charging module arranged in the second charging position, and the third charging module comprises a watch wireless charging module arranged in the watch charging element.

12. The mobile charging device according to claim 11, wherein the third charging position is provided with a receding groove, the watch charging element is movably connected with the housing assembly, and the receding groove is used for accommodating the watch charging element.
